(19) United States
(12) Patent Application Publication
(10) Pub. No.: US 2011/0276332 A1
(43) Pub. Date: Nov. 10, 2011

(54) SPEECH PROCESSING METHOD AND APPARATUS

(75) Inventors: Ranniery MAIA, Cambridge (GB); Byung Ha Chun, Cambridge (GB)

(73) Assignee: Kabushiki Kaisha Toshiba, Tokyo (JP)

(21) Appl. No.: 13/102,372

(22) Filed: May 6, 2011

(30) Foreign Application Priority Data
May 7, 2010 (GB) 1007705.5

(51) Int. Cl. G10L 13/00

(52) U.S. Cl. 704/260; 704/E13.001

(57) ABSTRACT

A speech synthesis method comprising:
receiving a text input and outputting speech corresponding to said text input using a stochastic model, said stochastic model comprising an acoustic model and an excitation model, said acoustic model having a plurality of model parameters describing probability distributions which relate a word or part thereof to a feature, said excitation model comprising excitation model parameters which are used to model the vocal chords and lungs to output the speech using said features;
wherein said acoustic parameters and excitation parameters have been jointly estimated; and
outputting said speech.

### CROSS REFERENCE TO RELATED APPLICATIONS

This application is based upon and claims the benefit of priority from UK application number 1007705.5 filed on May 7, 2010, the entire contents of which are incorporated herein by reference.

### FIELD

Embodiments of the present invention described herein generally relate to the field of speech synthesis.

### BACKGROUND

An acoustic model is used as the backbone of the speech synthesis. An acoustic model is used to relate a sequence of words or parts of words to a sequence of feature vectors. In statistical parametric speech synthesis, an excitation model is used in combination with the acoustic model. The excitation model is used to model the action of the lungs and vocal chords in order to output speech which is more natural.

In known statistical speech synthesis, features, such as cepstral coefficients are extracted from speech waveforms and their trajectories and modelled by a statistical model, such as a Hidden Markov Model (HMM). The parameters of the statistical model are estimated so as to maximize its likelihood to the training data or minimize an error between training data and generated features. At the synthesis stage, a sentence-level model is composed from the estimated statistical model according to an input text, and then features are generated from such sentence model so as to maximize their output probabilities or minimize an objective function.

### BRIEF DESCRIPTION OF THE DRAWINGS

The present invention will now be described with reference to the following non-limiting embodiments in which:

FIG. 1 is a schematic of a very basic speech synthesis system;

FIG. 2 is a schematic of the architecture of a processor configured for text-to-speech synthesis;

FIG. 3 is a block diagram of a speech synthesis system, the parameters of which are estimated in accordance with an embodiment of the present invention;

FIG. 4 is a plot of a Gaussian distribution relating a particular word or part thereof to an observation;

FIG. 5 is a flow diagram showing the initialisation steps in a method of training a speech synthesis model in accordance with an embodiment of the present invention;

FIG. 6 is a flow diagram showing the recursion steps in a method of training a speech synthesis model in accordance with an embodiment of the present invention; and

FIG. 7 is a flow diagram showing a method of speech synthesis in accordance with an embodiment of the present invention.

### DETAILED DESCRIPTION

Current speech synthesis systems often use a source filter model. In this model, an excitation signal is generated and filtered. A spectral feature sequence is extracted from speech and utilized to separately estimate acoustic model and excitation model parameters. Therefore, spectral features are not optimized by taking into account the excitation model and vice versa.

The inventors of the present invention have taken a completely different approach to the problem of estimating the acoustic and excitation model parameters and in an embodiment provide a method in which acoustic model parameters are jointly estimated with excitation model parameters in a way to maximize the likelihood of the speech waveform.

According to an embodiment, it is presumed that speech is represented by the convolution of a slowly varying vocal tract impulse response filter derived from spectral envelope features, and an excitation source. In the proposed approach extraction of spectral features is integrated in the interlaced training of acoustic and excitation models. Estimation of parameters of the models in question based on the maximum likelihood (ML) criterion can be viewed as full-fledge waveform level closed-loop training with the implicit minimization of the distance between natural and synthesized speech waveforms.

In an embodiment, a joint estimation of acoustic and excitation models for statistical parametric speech synthesis is based on maximum likelihood. The resulting system becomes what can be interpreted as a factor analyzed trajectory HMM. The approximations made for the estimation of the parameters of the joint acoustic and excitation model comprise fixing the state sequence fixed along the training and derivation of a one-best spectral coefficient vector.

In an embodiment, parameters of the acoustic model are updated by taking into account the excitation model, and parameters of the latter are calculated assuming spectrum generated from the acoustic model. The resulting system connects spectral envelope parameter extraction and excitation signal modelling in a fashion similar to factor analyzed trajectory HMM. The proposed approach can be interpreted as a waveform level closed-loop training to minimize the distance between natural and synthesized speech.

In an embodiment, acoustic and excitation models are jointly optimized from the speech waveform directly in a statistical framework.

Thus, the parameters are jointly estimated as:

$$\hat{λ} = arg {max}_{λ} p ( s \vert l , λ ) ,$$

where λ represents the parameters of the excitation model and acoustic model to be optimised, s is the natural speech waveform and l is a transcription of the speech waveform.

In an embodiment, the above training method can be applied to text-to-speech (TTS) synthesizers constructed according to the statistical parametric principle. Consequently, it can also be applied to any task in which such TTS systems are embedded, such as speech-to-speech translation and spoken dialog systems.

In one embodiment a source filter model is used where said text input is processed by said acoustic model to output F0 (fundamental frequency) and spectral features, the method further comprising: processing said F0 features to form a pulse train and filtering said pulse train using excitation parameters derived from said excitation model to produce an excitation signal and filtering said excitation signal using filter parameters derived from said spectral features.

The acoustic model parameters may comprise means and variances of said probability distributions. Examples of the features output by said acoustic model are F0 features and spectral features.

The excitation model parameters may comprise filter coefficients which are configured to filter a pulse signal derived from F0 features and white noise.

In an embodiment, said joint estimation process comprises a recursive process where in one step excitation parameters are updated using the latest estimate of acoustic parameters and in another step acoustic model parameters are updated using the latest estimate of excitation parameters. Preferably, said joint estimation process uses a maximum likelihood technique.

In a further embodiment, said stochastic model further comprises a mapping model and said mapping model comprises mapping model parameters, said mapping model being configured to map spectral features to filter coefficients which represent the human vocal tract. Preferably the relationship between the spectral features and filter coefficients is modelled as a Gaussian process.

Embodiment of the present invention can be implemented either in hardware or on software in a general purpose computer. Further the present invention can be implemented in a combination of hardware and software. The present invention can also be implemented by a single processing apparatus or a distributed network of processing apparatuses.

Since the present invention can be implemented by software, the present invention encompasses computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

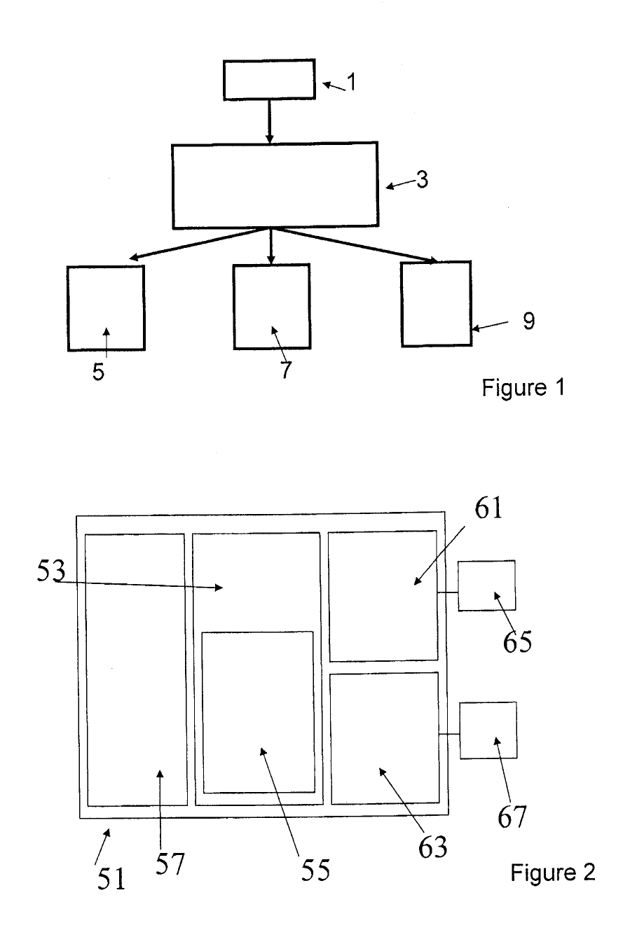

FIG. 1 is a schematic of a very basic speech processing system, the system of FIG. 1 has been configured for speech synthesis. Text is received via unit 1. Unit 1 may be a connection to the interne, a connection to a text output from a processor, an input from a speech to speech language processing module, a mobile phone etc. The unit 1 could be substituted by a memory which contains text data previously saved.

The text signal is then directed into a speech processor 3 which will be described in more detail with reference to FIG. 2.

The speech processor 3 takes the text signal and turns it into speech corresponding to the text signal. Many different forms of output are available. For example, the output may be in the form of a direct audio output 5 which outputs to a speaker. This could be implemented on a mobile telephone, satellite navigation system etc. Alternatively, the output could be saved as an audio file and directed to a memory. Also, the output could be in the form of an electronic audio signal which is provided to a further system 9.

FIG. 2 shows the basic architecture of a text to speech system 51. The text to speech system 51 comprises a processor 53 which executes a program 55. Text to speech system 51 further comprises storage 57. The storage 57 stores data which is used by program 55 to convert text to speech. The text to speech system 51 further comprises an input module 61 and an output module 63. The input module 61 is connected to a text input 65. Text input 65 receives text. The text input 65 may be for example a keyboard. Alternatively, text input 65 may be a means for receiving text data from an external storage medium or a network.

Connected to the output module 63 is output for audio 67. The audio output 67 is used for outputting a speech signal converted from text input into text input 63. The audio output 67 may be for example a direct audio output e.g. a speaker or an output for an audio data file which may be sent to a storage medium, networked etc.

In use, the text to speech system 51 receives text through text input 63. The program 55 executed on processor 53 coverts the text into speech data using data stored in the storage 57. The speech is output via the output module 65 to audio output 67.

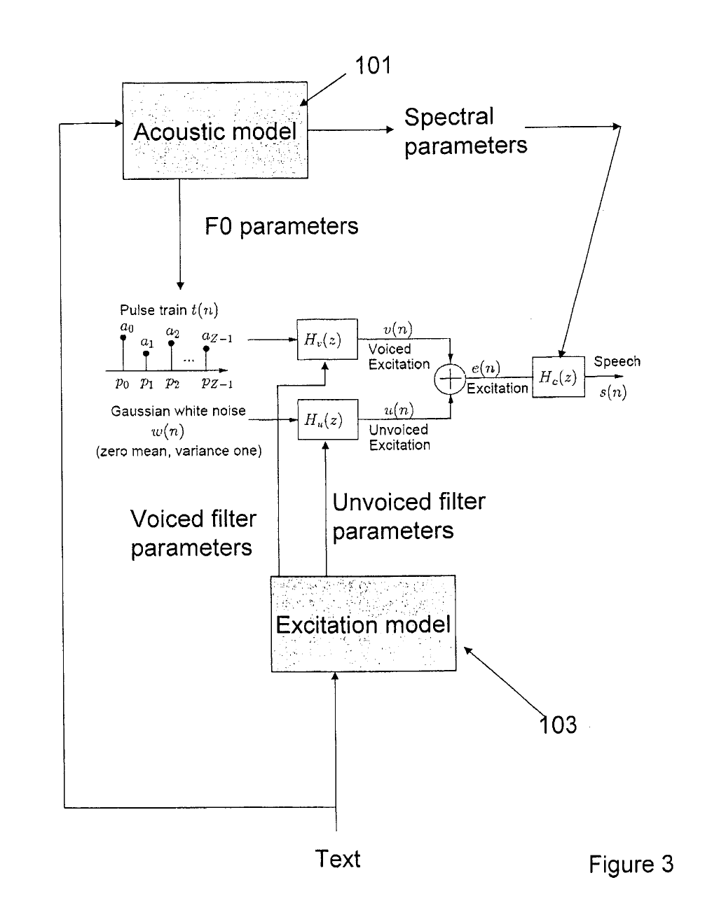

FIG. 3 is a schematic of a model of speech generation. The model has two sub-models: an acoustic model 101, and an excitation model 103.

Acoustic models where a word or part thereof are converted to features or feature vectors are well known in the art of speech synthesis. In this embodiment, an acoustic model is used which is based on a Hidden Markov Model (HMM). However, other models could also be used.

The actual model used in this embodiment is a standard model, the details of which are outside the scope of this patent application. However, the model will require the provision of probability density functions (pdfs) which relate to the probability of an observation represented by a feature vector being related to a word or part thereof. Generally, this probability distribution will be a Gaussian distribution in n-dimensional space.

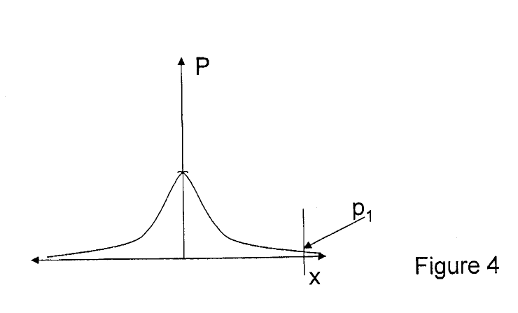

A schematic example of a generic Gaussian distribution is shown in FIG. 4. Here, the horizontal axis corresponds to a parameter of the input vector in one dimension and the probability distribution is for a particular word or part thereof relating to the observation. For example, in FIG. 4, an observation corresponding to a feature vector x has a probability p1 of corresponding to the word whose probability distribution is shown in FIG. 4. The shape and position of the Gaussian is defined by its mean and variance. These parameters are determined during training for the vocabulary which the acoustic model, they will be referred to as the “model parameters” for the acoustic model.

The text which is to be output into speech is first converted into phone labels. A phone label comprises a phoneme with contextual information about that phoneme. Examples of contextual information are the preceding and succeeding phonemes, the position within a word of the phoneme, the position of the word in a sentence etc. The phoneme labels are then input into the acoustic model.

The output of acoustic model HMM, once the model parameters have been determined, the model can be used to determine the likelihood of a sequence of observations corresponding to a sequence of words or parts of words.

In this particular embodiment, the features which are the output of acoustic model 101 are F0 features and spectral features. In this embodiment, the spectral features are cepstral coefficients. However, in other embodiments other spectral features could be used such as linear prediction coefficients (LPC), line spectral pairs (LSPs) and their frequency warped versions.

The spectral features are converted to form vocal tract filter coefficients expressed as h_{c}(n).

The generated F0 features are converted into a pulse train sequence t(n) and according to the F0 values, periods between pulse trains are determined.

The pulse train is a sequence of signals in the time domain, for example:

0100010000100
where 1 is pulse. The human vocal cord vibrates to generate periodic signals for voiced speech. The pulse train sequence is used to approximate these periodic signals.

A white noise excitation sequence w(n) is generated from white noise generator (not shown).

A pulse train t(n) and white noise sequences w(n) are filtered by excitation model parameters Hᵥ(z) and Hᵤ(z) respectively. The excitation model parameters are produced from excitation model 105. Hᵥ(z) represents the voiced impulse response filter coefficients and is sometimes referred to as the “glottis filter” since it represents the action of the glottis. Hᵤ(z) represents the unvoiced filter response coefficients. Hᵥ(z) and Hᵤ(z) together are excitation parameters which model the lungs and vocal chords.

Voiced excitation signal v(n) which is a time domain signal is produced from the filtered pulse train and unvoiced excitation signal u(n) which is also a time domain signal is produced from the white noise w(n). These signal v(n) and u(n) are mixed (added) to compose the mixed excitation signals in time domain, e(n).

Finally, excitation signals e(n) are filtered by impulse response H_{c}(z) derived from the spectral features derived as explained above to obtain speech waveform s(n).

In a speech synthesis software product, the product comprises a memory which contains coefficients of Hᵥ(z) and Hᵤ(z) along with the acoustic model parameters such as means and variances. The product will also contain data which allows spectral features outputted from the acoustic model to be converted to H_{c}(z). When the spectral features are cepstral coefficients, the conversion of the spectral features to H_{c}(z) is deterministic and not dependent on the nature of the data used to train the stochastic model. However, if the spectral features comprise other features such as linear prediction coefficients (LPC), line spectral pairs (LSPs) and their frequency warped versions, then the mapping between the spectral features and H_{c}(z) is not deterministic and needs to be estimated when the acoustic and excitation parameters are estimated. However, regardless of whether the mapping between the spectral features and H_{c}(z) is deterministic or estimated using a mapping model, in a preferred embodiment, a software synthesis product will just comprise the information needed to convert spectral features to H_{c}(z).

Training of a speech synthesis system involves estimating the parameters of the models. In the above system, the acoustic, excitation and mapping model parameters are to be estimated. However, it should be noted that the mapping model parameters can be removed and this will be described later.

In a training method in accordance with an embodiment of the present invention, the acoustic model parameters and the excitation model parameters are estimated at the same time in the same process.

To understand the differences, first a conventional framework for estimating these parameters will be described.

In known statistical parametric speech synthesis, first a “super-vector” of speech features c=[c₀^{T} . . . c_{T-1}^{T}]^{T} is extracted from the speech waveform, where cₜ=[cₜ(0) . . . cₜ(C)]^{T} is a C-th order speech parameter vector at frame t, and T is the total number of frames. Estimation of acoustic model parameters is usually done through the ML criterion:

$${\hat{λ}}_{c} = arg {max}_{{λ}_{c}} p ( c \vert l , {λ}_{c} ) , \qquad ( 1 )$$

where l is a transcription of the speech waveform and λ_{c} denotes a set of acoustic model parameters.

During the synthesis, a speech feature vector c′ is generated for a given text to be synthesized l′ so as to maximize its output probability

$${\hat{c}}^{′} = arg {max}_{{c}^{′}} p ( {c}^{′} \vert {l}^{′} , {\hat{λ}}_{c} ) . \qquad ( 2 )$$

These features together with F₀ and possibly duration, are utilized to generate speech waveform by using the source-filter production approach as described with reference to FIG. 3.

A training method in accordance with an embodiment of the present invention uses a different approach. Since the intention of any speech synthesizer is to mimic the speech waveform as well as possible, in an embodiment of the present invention a statistical model defined at the waveform level is proposed The parameters of the proposed model are estimated so as to maximize the likelihood of the waveform itself, i.e.,

$$\hat{λ} = arg {max}_{λ} p ( s \vert l , λ ) , \qquad ( 3 )$$

where s=[s(0) . . . s(N−1)]^{T} is a vector containing the entire speech waveform, s(n) is a waveform value at sample n, N is the number of samples, and λ denotes the set of parameters of the joint acoustic-excitation models.

By introducing two hidden variables: the state sequence q={q₀, . . . , q_{T-1}} (discrete) spectral parameter c=[c₀^{T} . . . C_{T-1}^{T}]_{T} (continuous), Eq. (3) can be rewritten as:

$$\begin{matrix}\hat{λ} = arg {max}_{λ} {\sum }_{∀ q}^{ } {\int }_{ }^{ } p ( s , c , q \vert l , λ ) d c \\ = arg {max}_{λ} {\sum }_{∀ q}^{ } {\int }_{ }^{ } p ( s \vert c , q , λ ) p ( c \vert q , λ ) p ( q \vert l , λ ) d c ,\end{matrix} \qquad \begin{matrix}\begin{matrix}( 4 ) \\ \end{matrix} \\ ( 5 )\end{matrix}$$

where qₜ is the state at frame t.

Terms p(s|c,q,λ), and p(c|q,λ) and p(q|l,λ) of Eq. (5) can be analysed separately as follows:
p(s|c,q,λ): This probability concerns the speech waveform generation from spectral features and a given state sequence. The maximization of this probability with respect to λ is closely related to the ML estimation of spectral model parameters. This probability is related to the assumed speech signal generative model.
p(c|q,λ): This probability is given as the product of state-output probabilities of speech parameter vectors if HMMs or hidden semi-Markov models (HSMMs) are used as its acoustic model. If trajectory HMMs are used, this probability is given as a state-sequence-output probability of entire speech parameter vector.
p(q|l,λ): This probability gives the probability of state sequence q for a transcription l. If HMM or trajectory HMM is used as acoustic model, this probability is given as a product of state-transition probabilities. If HSMM or trajectory HSMM is used, it includes both state-transition and state-duration probabilities.

It is possible to model p(c|q,λ) and p(q|l,λ) using existing acoustic models, such as HMM, HSMM or trajectory HMMs, the problem is how to model p(s|c,q,λ).

It is assumed that the speech signal is generated according to the diagram of FIG. 4, i.e.,

s(n)=h_{c}(n)*[hᵥ(n)*t(n)+hᵤ(n)*w(n)], (6)

where * denotes linear convolution and
h_{c}(n): is the vocal tract filter impulse response;
t(n): is a pulse train;
w(n): is a Gaussian white noise sequence with mean zero and variance one;
hᵥ(n): is the unvoiced filter impulse response;
hᵤ(n): is the unvoiced filter impulse response;

Here the vocal tract, voiced and unvoiced filters are assumed to have respectively the following shapes in the z-transform domain:

$$\begin{matrix}{H}_{c} ( z ) = {\sum }_{p = 0}^{P} {h}_{c} ( p ) {z}^{- p} & ( 7 ) \\ {H}_{v} ( z ) = {\sum }_{m = - \frac{M}{2}}^{\frac{M}{2}} {h}_{v} ( m ) {z}^{- m} , & ( 8 ) \\ {H}_{u} ( z ) = \frac{K}{1 - {\sum }_{l = 1}^{L} g ( l ) {z}^{- 1}} , & ( 9 )\end{matrix}$$

where P, M and L are respectively the orders of H_{c}(z), Hᵥ(z) and Hᵤ(z). Filter H_{c}(z) is considered to have minimum-phase response because it represents the impulse response of the vocal tract filter. In addition, if the coefficients of Hᵤ(z) to be calculated according to the approach described in R. Maia, T. Toda, H. Zen, Y. Nakaku, and K. Tokuda, “An excitation model for HMM-based speech synthesis based on residual modelling,” in Proc. of the 6^{th} ISCA Workshop on Speech Synthesis, 2007 then H_{c}(z) also has minimum-phase response. Parameters of the generative model above comprise the vocal tract, voiced and unvoiced filters, H_{c}(z), Hᵥ(z) and Hᵤ(z), and the positions and amplitudes of t(n), {p₀ . . . p_{Z-1}}, and {a₀ . . . a_{Z-1}} with Z being the number of pulses. Although there are several ways to estimate Hᵥ(z) and Hᵤ(z), this report will be based on the method described in R. Maia, T. Toda, H. Zen, Y. Nakaku, and K. Tokuda, “An excitation model for HMM-based speech synthesis based on residual modelling,” in Proc. of the 6^{th} ISCA Workshop on Speech Synthesis, 2007.

Using matrix notation, with uppercase and lowercase capital letters meaning respectively matrices and vectors, Eq(6) can be written as:

s=H_{c}Hᵥt+sᵤ, (10)

where

$$\begin{matrix}s = {[ s ( - \frac{M}{2} ) … s ( N + \frac{M}{2} + P - 1 ) ]}^{T} , & ( 11 ) \\ {H}_{c} = [ {\tilde{h}}_{c}^{( 0 )} … {\tilde{h}}_{c}^{( N + M - 1 )} ] , & ( 12 ) \\ {h}_{c}^{( i )} = {[ {\underbrace{0 … 0}}_{i} {h}_{c} ( 0 ) … {h}_{c} ( P ) {\underbrace{0 … 0}}_{N + M - i - 1} ]}^{T} , & ( 13 ) \\ {H}_{v} = [ {\tilde{h}}_{v}^{( 0 )} … {\tilde{h}}_{v}^{( N - 1 )} ] , & ( 14 ) \\ {\tilde{h}}_{v}^{( i )} = {[ {\underbrace{0 … 0}}_{i} {h}_{v} ( - \frac{M}{2} ) … {h}_{v} ( \frac{M}{2} ) {\underbrace{0 … 0}}_{N - i - 1} ]}^{T} , & ( 15 ) \\ t = {[ t ( 0 ) … t ( N - 1 ) ]}^{T} , & ( 16 ) \\ {s}_{u} = {[ {\underbrace{0 … 0}}_{\frac{M}{2}} {s}_{u} ( 0 ) … {s}_{u} ( N + L - 1 ) {\underbrace{0 … 0}}_{\frac{M}{2} + P - L} ]}^{T} . & ( 17 )\end{matrix}$$

The vector sᵤ contains samples of

sᵤ(n)=h_{c}(n)*hᵤ(n)*w(n), (17)

and can be interpreted as the error of the model for voiced regions of the speech signal, with covariance matrix

Φ=H_{c}(G^{T}G)⁻¹H_{c}^{T}, (19)

where

$$\begin{matrix}G = [ {\begin{matrix}{\tilde{g}}^{( 0 )} & … & \tilde{g}\end{matrix}}^{( N + M - 1 )} ] , & ( 20 ) \\ {\tilde{g}}^{( 1 )} = {[ \begin{matrix}\underbrace{0 … , 0}_{i} & \frac{1}{K} & \frac{g ( 1 )}{K} & … & \frac{g ( L )}{K} & \underbrace{0 … 0}_{N + M - i - 1}\end{matrix} ]}^{T} . & ( 21 )\end{matrix}$$

As w(n) is Gaussian white noise, u(n)=hᵤ(n)*w(n) becomes a normally distributed stochastic process. By using vector notation, probability u is

p(u|G)=N(u;0,(G^{T}G)⁻¹), (22)

Where N(x;μ,Σ) is the Gaussian distribution of x with mean vector μ and covariance matrix Σ. Thus since

u(n)=H_{c}⁻¹(z)[s(n)−h(n)*hᵥ(n)*t(n)], (23)

the probability of speech vector s becomes

p(s|H_{c},Hᵥ,G,t)=N(s;H_{c}Hᵥt,H_{c}(G^{T}G)⁻¹H_{c}^{T}). (24)

If the last P rows of H_{c} are neglected, which means neglecting the zero-impulse response of H_{c}(z) which produces samples

$$\{ s ( N + \frac{M}{2} ) , … , s ( N + \frac{M}{2} + P - 1 ) \} ,$$

then H_{c} becomes square with dimensions (N+M)×(N+M) equation (24) can be re-written as:

p(s|H_{c},λₑ)=|H_{c}|⁻¹N(H_{c}⁻¹s;Hᵥt,(G^{T}G)⁻¹), (25)

where λₑ={Hᵥ,G,t} are parameters of the excitation modelling part of the speech generative model. It is interesting to note that the term H_{c}⁻¹s corresponds to the residual sequence, extracted from the speech signal s(n) through inverse filtering by H_{c}(z).

By assuming that Hᵥ and Hᵤ have a state-dependent parameter tying structure as that proposed in R. Maia, T. Toda, H. Zen, Y. Nakaku, and K. Tokuda, “An excitation model for HMM-based speech synthesis based on residual modelling,” in Proc. of the 6^{th} ISCA Workshop on Speech Synthesis, 2007 Eq. (25) can be re-written as

p(s|H_{c},q,λₑ)=|H_{c}|⁻¹N(H_{c}⁻¹s;H_{v,q}t,(G_{q}^{T}G_{q})⁻¹), (26)

where H_{v,q} and G_{q} are respectively the voiced filter and inverse unvoiced filter impulse response matrices for state sequence q.

There is usually a one-to-one relationship between the vocal tract impulse response H_{c} (or coefficients of H_{c}(z)) and spectral features c. However, it is difficult to compute H_{c}, from c in a closed form for some spectral feature representations. To address this problem, a stochastic approximation is introduced to model the relationship between c and H.

If the mapping between c and H_{c} is considered to be represented by a Gaussian process with probability p(H_{c}|c,q,λₕ) where λₕ is the parameter set of the model that maps spectral features onto vocal tract filter impulse response, p(s|c,q,λₑ) becomes:

$$\begin{matrix}p ( s \vert c , q , {λ}_{c} ) = \int p ( s \vert {H}_{c} q , {λ}_{e} ) p ( {H}_{c} \vert c , q , {λ}_{h} ) d {H}_{c} & ( 27 ) \\ = \int N ( {H}_{c}^{- 1} s ; {H}_{v , q} t , {( {G}_{q}^{T} {G}_{q} )}^{- 1} ) N ( {H}_{c} ; {f}_{q} ( c ) , {Ω}_{q} ) , & ( 28 )\end{matrix}$$

Where f_{q}(c) is an approximated function to convert c to H_{c} and Ω_{q} is the covariance matrix of the Gaussian distribution in question. This representation includes the case that H_{c} can be computed from c in a closed form as its special case, i.e. f_{q}(c) becomes the mapping function in the closed form and Ω_{q} becomes a zero matrix. It is interesting to note that the resultant model becomes very similar to that of a shared factor analysis model if a linear function for f_{q}(c) is utilized and it has a parameter sharing structure dependent on q.

If a trajectory HMM is used as an acoustic model p(c|l,λ_{c}) then p(c|q,λ_{c}) and p(q|l,λ_{c}) can be defined as:

$$\begin{matrix}p ( c \vert q , {λ}_{c} ) = N ( c ; {\overline{c}}_{q} , {P}_{q} ) , & ( 29 ) \\ p ( q \vert l , {λ}_{c} ) = {π}_{q o} {\prod }_{t = 1}^{T - 1} {α}_{{q}_{t} {q}_{t + 1}} , & ( 30 )\end{matrix}$$

where πᵢ is the initial state probability of state i, αᵢⱼ is the state transition probability from state i to state j, and c̅_{q} and P_{q} correspond to mean vector and covariance matrix of trajectory HMM for q. In Eq. (29), c̅_{q} and P_{q} are given as

R_{q} c̅_{q}=τ_{q}, (31)

R_{q}=W^{T}Σ_{q}⁻¹W=P_{q}⁻¹, (32)

r_{q}=W^{T}Σ_{q}⁻¹μ_{q}, (33)

where W is typically a 3T(C+1)×T(C+1) window matrix that appends dynamic features(velocity and acceleration features) to c. For example, if the static, velocity, and acceleration features of cₜ, Δ⁽⁰⁾cₜ, Δ⁽¹⁾cₜ and Δ⁽²⁾cₜ are calculated as:

Δ⁽⁰⁾zₜ=zₜ, (34)

Δ⁽¹⁾zₜ=(zₜ₊₁−zₜ₋₁)/2, (35)

Δ⁽²⁾zₜ=zₜ₋₁−2zₜ+zₜ₊₁, (36)

then W is as follows

$$[ \begin{matrix}⋮ \\ {Δ}^{( 0 )} {c}_{t - 1} \\ {Δ}^{( 1 )} {c}_{t - 1} \\ {Δ}^{( 2 )} {c}_{t - 1} \\ {Δ}^{( 0 )} {c}_{t} \\ {Δ}^{( 1 )} {c}_{t} \\ {Δ}^{( 2 )} {c}_{t} \\ {Δ}^{( 0 )} {c}_{t + 1} \\ {Δ}^{( 1 )} {c}_{t + 1} \\ {Δ}^{( 2 )} {c}_{t + 1} \\ ⋮\end{matrix} ] = [ \begin{matrix}… & ⋮ & ⋮ & ⋮ & ⋮ & … \\ … & 0 & I & 0 & 0 & … \\ … & - I / 2 & 0 & I / 2 & 0 & … \\ … & I & - 2 I & I & 0 & … \\ … & 0 & 0 & I & 0 & … \\ … & 0 & - I / 2 & 0 & I / 2 & … \\ … & 0 & I & - 2 I & I & … \\ … & 0 & 0 & 0 & I & … \\ … & 0 & 0 & - I / 2 & 0 & … \\ … & 0 & 0 & I & - 2 I & … \\ … & ⋮ & ⋮ & ⋮ & ⋮ & …\end{matrix} ] [ \begin{matrix}⋮ \\ {c}_{t - 2} \\ {c}_{t - 1} \\ {c}_{t} \\ {c}_{i + 1} \\ ⋮\end{matrix} ] \qquad ( 37 )$$

where I and 0 correspond to the (C+1)×(C+1) identity and zero matrices. λ_{q} and Σ_{q}⁻¹ in Eqs. (32) and (33) corresponds to the 3T(C+1)×1 mean parameter vector and the 3T(C+1)×3 T(C+1) precision parameter matrix for the state sequence q, given as

μ_{q}=[μ_{q}_{₀}^{T} . . . μ_{q}_{_{T−1}}^{T}]^{T}, (38)

Σ_{q}⁻¹=diag{Σ_{q}_{₀}⁻¹, . . . , Σ_{q}_{_{T−1}}⁻¹}, (39)

where μᵢ and Σᵢ correspond to the 3(C+1) mean-parameter vector and the 3(C+1)×3(C+1) precision-parameter matrix associated with state i, and Y=diag {X₁, . . . , X_{D}} means that matrices {X₁, . . . , X_{D}} are diagonal sub-matrices of Y. Mean parameter vectors and precision parameter matrices are defined as

μi=[Δ⁽⁰⁾μᵢ^{T}Δ⁽¹⁾μᵢ^{T}Δ⁽²⁾μᵢ^{T}]^{T}, (40)

Σᵢ⁻¹=diag{Δ⁽⁰⁾Σᵢ⁻¹,Δ⁽¹⁾Σᵢ⁻¹,Δ⁽²⁾Σᵢ^{T}}, (41)

Where Δ^{(j)}μᵢ and Δ^{(j)}Σᵢ⁻¹ correspond to the (C+1)×1 mean parameter vector and (C+1)×(C+1) precision parameter matrix associated with state i.

The final parameter model is obtained by combing the acoustic and excitation models via the mapping model as:

$$p ( s \vert l , λ ) = {\sum }_{q} \int \int p ( s \vert {H}_{c} , q , {λ}_{e} ) p ( {H}_{c} \vert c , q , {λ}_{h} ) p ( c \vert q , {λ}_{c} ) p ( q \vert l , {λ}_{c} ) d {H}_{c} d c , \qquad ( 42 )$$

where

$$\begin{matrix}p ( s \vert {H}_{c} , q , {λ}_{e} ) = {\vert {H}_{c} \vert}^{- 1} N ( {H}_{c}^{- 1} s ; {H}_{v , q} t , {( {G}_{q}^{T} {G}_{q} )}^{- 1} ) , & ( 43 ) \\ p ( {H}_{c} \vert c , q , {λ}_{h} ) = N ( {H}_{c} ; {f}_{q} ( c ) , {Ω}_{q} ) , & ( 44 ) \\ p ( c \vert q , {λ}_{c} ) = N ( c ; {\overline{c}}_{q} , {P}_{q} ) , & ( 45 ) \\ p ( q \vert l , {λ}_{c} ) = {π}_{qo} {\prod }_{t = 1}^{T - 1} {α}_{{q}_{t} {q}_{t + 1}} , & ( 46 )\end{matrix}$$

Where λ={λₑ,λₕ,λ_{c}}

There are various possible spectral features, such as cepstral coefficients, linear prediction coefficients (LPC), line spectral pairs (LSPs) and their frequency warped versions. In this embodiment cepstral coefficients are considered as a special case. The mapping from a cepstral coefficient vector, cₜ=[cₜ(0) . . . cₜ(C)]^{T}, to its corresponding vocal tract filter impulse response vector h_{c,t}=[h_{c,t}(0) . . . h_{c,t}(P)]^{T} can be written in a closed form as

h_{c,t}=Dₛ*·EXP[Dₛcₜ], (47)

Where EXP [.] means a matrix which is derived by taking the exponential of the elements of [.] and D is a (P+1)×(C+1) DFT (Discrete Fourier Transform) matrix,

$${D}_{s} = [ \begin{matrix}1 & 1 & … & 1 \\ 1 & {W}_{P + 1} & … & {W}_{P + 1}^{C} \\ ⋮ & ⋮ & & ⋮ \\ 1 & {W}_{P + 1}^{P} & … & {W}_{P + 1}^{PC}\end{matrix} ] , \qquad ( 48 )$$

### With

W_{P+1}=e^{-2π/P+1j}, (49)

and D* is a (P+1)×(P+1) IDFT (Inverse DFT) matrix with the following form

$${D}_{s}^{*} = \frac{1}{P + 1} [ \begin{matrix}1 & 1 & … & 1 \\ 1 & {W}_{P + 1}^{- 1} & … & {W}_{P + 1}^{- P} \\ ⋮ & ⋮ & & ⋮ \\ 1 & {W}_{P + 1}^{- P} & … & {W}_{P + 1}^{- {P}^{2}}\end{matrix} ] . \qquad ( 50 )$$

As the mapping between cepstral coefficients and vocal tract filter response can be computer in a closed form. There is no need to use a stochastic approximation between c and H_{c}.

The vocal tract filter impulse response-related term that appears in the generative model of Eq. (10) is H_{C} not h_{c}. Relationship between H_{C} given as Eqs. (12) and (13), and h_{c} is given by

h_{c}=[h_{c,0}^{T} . . . h_{c,T-1}^{T}]^{T} (51)

h_{c,t}[h_{c,t}(0) . . . h_{c,t}(P)]^{T} (52)

With h_{c,t} being the synthesis filter impulse response of the t-th frame and T the total of frames, can be written as

$${H}_{c} = {\sum }_{n = 0}^{N - 1} {J}_{n} {Bh}_{c} {j}_{n}^{T} . \qquad ( 53 )$$

In Eq. (53), N is the number of samples (of the database), and

$$\begin{matrix}{j}_{n} = {[ \begin{matrix}\underbrace{0 … 0}_{n} & 1 & \underbrace{0 … 0}_{N - 1 - n}\end{matrix} ]}^{T} , & ( 54 ) \\ B = [ \begin{matrix}{I}_{P + 1} & {0}_{P + 1 , P + 1} & … & {0}_{P + 1 , P + 1} \\ ⋮ & ⋮ & & ⋮ \\ {I}_{P + 1} & {0}_{P + 1 , P + 1} & … & {0}_{P + 1 , P + 1} \\ … & … & … & … \\ ⋮ & ⋮ & & ⋮ \\ … & … & … & … \\ {0}_{P + 1 , P + 1} & {0}_{P + 1 , P + 1} & … & {I}_{P + 1} \\ ⋮ & ⋮ & & ⋮ \\ {0}_{P + 1 , P + 1} & {0}_{P + 1 , P + 1} & … & {I}_{P + 1}\end{matrix} ] , & ( 55 )\end{matrix}$$

Where B is an N(P+1)×T(P+1) matrix to map a frame-basis h_{c} vector into sample-basis. It should be noted that the square version of H_{c} is considered by neglecting the last P rows. The N×N(P+1) matrices Jₙ are constructed as

$$\begin{matrix}{J}_{0} = [ \begin{matrix}{I}_{P + 1} & {I}_{P + 1} , N ( P + 1 ) - P - 1 \\ … & … \\ {0}_{N - P - 1 , P + 1} & {0}_{N - P - 1 , N ( P + 1 ) - P - 1}\end{matrix} ] , & ( 56 ) \\ {J}_{1} = [ \begin{matrix}{0}_{1 P + 1} & {0}_{1 P + 1} & {0}_{1 , N ( P + 1 ) - 2 P - 2} \\ … & … & … \\ {0}_{P + 1 P + 1} & {I}_{P + 1} & {0}_{P + 1 , N ( P + 1 ) - 2 P - 2} \\ … & … & … \\ {0}_{N - P - 2 , P + 1} & {0}_{N - P - 2 , P + 1} & {0}_{N - P - 2 , N ( P + 1 ) - 2 P - 2}\end{matrix} ] , \\ ⋮ & ( 57 ) \\ {J}_{N - 1} = [ \begin{matrix}{0}_{N - 1 , N ( P + 1 ) - P - 1} & {0}_{N - 1 , 1} & {0}_{N - 1 , P} \\ … & … & … \\ {0}_{1 , N ( P + 1 ) - P - 1} & 1 & {0}_{1 , P}\end{matrix} ] & ( 58 )\end{matrix}$$

where 0_{X,Y} means a matrix of zeros elements with X rows and Y columns, and I_{X} is an X-size identity matrix.

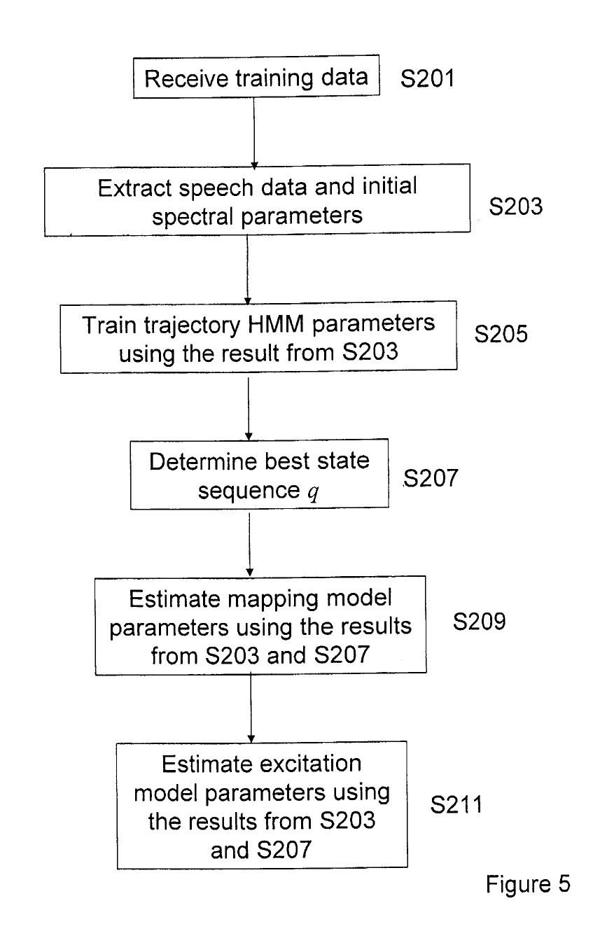

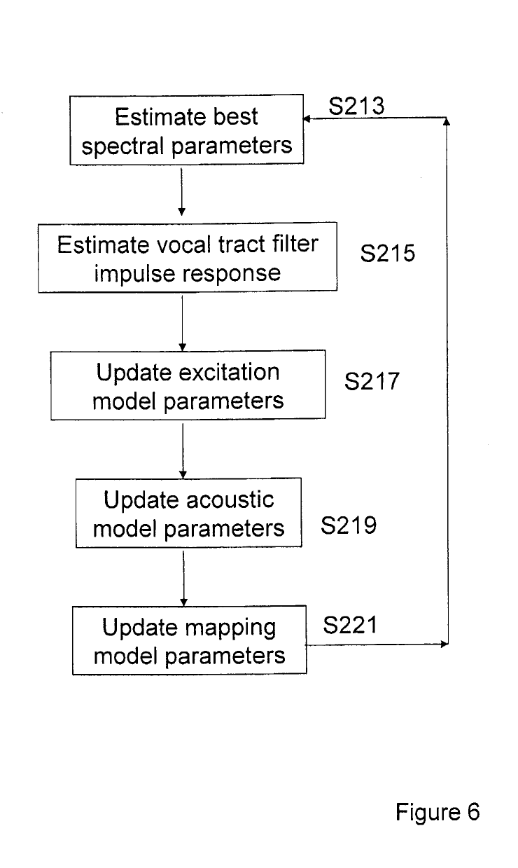

The training of the model will now be described with reference to FIGS. 5 and 6.

The training allows the parameters of the joint model X to be estimated such that:

$$\hat{λ} = arg {max}_{λ} p ( s \vert l , λ ) , \qquad ( 59 )$$

where λ={λₑ,λₕ,λ_{c}} with λₑ={Hᵥ,G,t} corresponding to parameters of the excitation model, and λ={m,σ} consisting of parameters of the acoustic model

m=[μ₀^{T} . . . μ_{S-1}^{T}]′, (60)

σ=vdiag{diag{Σ₀⁻¹, . . . , Σ_{S-1}⁻¹}}, (61)

where S is the number of states. m and σ are respectively vectors formed by concatenating all the means and diagonals of the inverse covariance matrices of all states, with vdiag {[.]} meaning a vector formed by the diagonal elements of [.].

The likelihood function p(s|l,λ) assuming cepstral coefficients as spectral features, is

$$p ( s \vert l , λ ) = {\sum }_{∀ q} \int \int p ( s \vert {H}_{c} , q , {λ}_{e} ) p ( {H}_{c} \vert c , q , {λ}_{h} ) p ( c \vert q , {λ}_{c} ) p ( q \vert l , {λ}_{c} ) d {H}_{c} d c , \qquad ( 62 )$$

Unfortunately, estimation of this model through the expectation-maximization (EM) is intractable. Therefore, an approximate recursive approach is adopted.

If the summation over all possible g in Eq. (62) is approximated by a fixed state sequence the likelihood function above becomes

p(s|l,λ)≈∫∫p(s|H_{c},\hat{q},λₑ)p(H_{c}|c,\hat{q},λₕ)p(c|\hat{q},λ_{c})p(\hat{q}|l,λ_{c})dc, (63)

where \hat{q}={\hat{q}₀, . . . , \hat{q}_{T-1}} is the state sequence. Further, if the integration over all possible c is approximated by a spectral vector and an impulse response vector, then Eq. (64) becomes

p(s|l,λ)≈p(s|Ĥc,\hat{q},λₑ)p(Ĥ_{c}|ĉ,\hat{q},λₕ)p(ĉ|\hat{q},λ_{c})p(\hat{q}|l,λ_{c}), (64)

where ĉ=[ĉ₁ . . . ĉ_{T-1}]^{T} is the fixed spectral response vector.

By taking the logarithm of Eq. (64) or cost function to be maximized is obtained through update of acoustic, excitation and mapping model parameters

L=log p(s|Ĥc,\hat{q},λₑ)+log p(Ĥ_{c}|ĉ,\hat{q},λh)+log p(ĉ|\hat{q},λ_{c})+log p(\hat{q}|ₗ,λ_{c}). (65)

The optimization problem can be split into two parts: initialization and recursion. The following explains the calculations performed in each part. Initialisation will be described with reference to FIG. 5 and recursion with reference to FIG. 6.

The model is trained using training data which is speech data with corresponding text data and which is input in step S210

### Part 1—Initialization

1. In step S203 speech data is extracted from an initial cepstral coefficient vector

c=[c₀^{T} . . . c_{T-1}^{T}], (66)

cₜ=[c_{c}(0) . . . c_{c}(C)]^{T}. (67)
2. In step S205 trajectory HMM parameters λ_{c} are trained using c

$$\hat{{λ}_{c}} = arg {max}_{λ c} p ( c \vert {λ}_{c} ) . \qquad ( 68 )$$

3. In step S207 the best state sequence \hat{q}is determined as the Viterbi path from the trained models by using the algorithm of H. Zen, K. Tokuda, and T. Kitamura, “Reformulating the HMM as a trajectory model by imposing explicit relationships between static and dynamic feature vector sequence,” Computer Speech and Language, vol. 21, pp. 153-173, January 2007.

$$\hat{q} = arg {max}_{q} p ( c , q \vert {λ}_{c} ) . \qquad ( 69 )$$

4. In step S209, the mapping model parameters λₕ are estimated assuming \hat{q} and c.

$$\hat{{λ}_{h}} = arg {max}_{{λ}_{e}} p ( {H}_{c} \vert c , \hat{q} , {λ}_{h} ) . \qquad ( 70 )$$

5. In step S211, the excitation parameters λₑ are estimated assuming \hat{q} and c, by using one iteration of the algorithm described in R. Maia, T. Toda, H. Zen, Y. Nakaku, and K. Tokuda, “An excitation model for HMM-based speech synthesis based on residual modelling,” in Proc. of the 6^{th} ISCA Workshop on Speech Synthesis, 2007.

$$\hat{{λ}_{e}} = arg {max}_{{λ}_{e}} p ( s \vert {H}_{c} , \hat{q} , {λ}_{e} ) . \qquad ( 71 )$$

### Part 2: Recursion

1. In step S213 of FIG. 6 the best cepstral coefficient vector c is estimated using the log likelihood function of Eq. (65)

$$\hat{c} = arg {max}_{c} ℒ . \qquad ( 72 )$$

2. In step S215 the vocal tract filter impulse responses H_{c} are estimated assuming \hat{q} and ĉ.

$${\hat{H}}_{c} = arg {max}_{{H}_{c}} ℒ . \qquad ( 73 )$$

3. In step S217 excitation model parameters λₑ are updated assuming \hat{q} and Ĥ_{c}

$${\hat{λ}}_{e} = arg {max}_{{λ}_{e}} ℒ . \qquad ( 74 )$$

4. In step S219 acoustic model parameters are updated

$${\hat{λ}}_{c} = arg {max}_{{λ}_{c}} ℒ . \qquad ( 75 )$$

5. In step S221 mapping model parameters are updated

$${\hat{λ}}_{h} = arg {max}_{{λ}_{h}} ℒ . \qquad ( 76 )$$

The recursive steps may be repeated several times. In the following each one of them is explained with details

The recursion terminates until convergence. Convergence may be determined in many different ways, in one embodiment, convergence will be deemed to have occurred when the change in likelihood is less than a predefined minimum value. For example the change in likelihood L is less than 5%.

In step 1 S 213 of the recursion, if cepstral coefficients are used as the spectral features then the likelihood function of Eq. (65) can be written as

$$ℒ = - \frac{1}{2} \{ ( N + M ) log ( 2 π ) + log \vert {G}_{q}^{T} {G}_{q} \vert - 2 log \vert {H}_{c} \vert + {s}^{T} {H}_{c}^{- T} {G}_{q}^{T} {G}_{q} {H}_{c}^{- 1} s -- 2 {s}^{T} {H}_{c}^{- T} {G}_{q}^{T} {G}_{q} {H}_{v , q} t + {t}^{T} {H}_{v , q}^{T} {G}_{q}^{T} {G}_{q} {H}_{v , q} t + T ( C + 1 ) log ( 2 π ) -- log \vert {R}_{q} \vert + {c}^{T} {R}_{q} c - 2 {r}_{q}^{T} c + {r}_{q}^{T} {R}_{q}^{- 1} {r}_{q} \} , \qquad ( 77 )$$

Where the terms that depend on c can be selected to compose the cost function h_{c} given by:

$${ℒ}_{c} = - \frac{1}{2} {s}^{T} {H}_{c}^{- T} {G}_{q}^{T} {G}_{q} {H}_{c}^{- 1} s + log \vert {H}_{c} \vert + {s}^{T} {H}_{c}^{- T} {G}_{q}^{T} {G}_{q} {H}_{v , q} t - \frac{1}{2} {c}^{T} {R}_{q} c + {r}_{q}^{T} c . \qquad ( 78 )$$

The best cepstral coefficient vector ĉ can be defined as the one which maximizes the cost function h_{c}. By utilizing the steepest gradient ascent algorithm (see for example J. Nocedal and S. J. Wright, Numerical Optimization. Springer, 1999) or another optimization method such as the Broyden Fletcher Goldfarb Shanno (BFGS) algorithm, each update for ĉ can be calculated by

$${\hat{c}}^{( i + 1 )} = {\hat{c}}^{( i )} + γ \frac{\partial {ℒ}_{c}}{\partial c} , \qquad ( 79 )$$

Where is the convergence factor (constant), t is the iteration index, and

$$\frac{\partial ℒ}{\partial c} = {D}^{T} DIAG ( EXP [ Dc ] ) {D}^{* T} {B}^{T} \{ {\sum }_{n = 0}^{N - 1} {J}_{n}^{T} {H}_{c}^{- T} [ {G}_{q}^{T} {G}_{q} ( e - v ) {e}^{T} - I ] {j}_{n} \} - {R}_{q} c + {r}_{q} , \qquad ( 80 )$$

with Diag ([.]) meaning a diagonal matrix formed with the elements of vector [.], and

$$\begin{matrix}e = {H}_{c}^{- 1} s , & ( 81 ) \\ v = {H}_{v , q} t , & ( 82 ) \\ D = diag \{ \underbrace{{D}_{s} , … , {D}_{s}}_{T} \} , & ( 83 ) \\ D = diag \{ \underbrace{{D}_{s}^{*} , … , {D}_{s}^{*}}_{T} \} . & ( 84 )\end{matrix}$$

In the above, the iterative process will continue until convergence. In a preferred embodiment, convergence will have occurred when the difference between successive iterations is less than 5%.

In Step 3 S217 of the recursive procedure, excitation parameters λₑ={Hᵥ,G,G} are calculated by using one iteration of the algorithm describe in R. Maia, T. Toda, H. Zen, Y. Nakaku, and K. Tokuda, “An excitation model for HMM-based speech synthesis based on residual modelling,” in Proc. Of the 6^{th} ISCA Workshop on Speech Synthesis, 2007. In this case the estimated cepstral vector ĉ is used to extract the residual vector e=H_{c}⁻¹s through inverse filtering.

In step 4 S219 estimation of acoustic model parameters λ={m,σ} is done as described in H. Zen, K. Tokuda, and T. Kitamura, “Reformulating the HMM as a trajectory model by imposing explicit relationships between static and dynamic feature vector sequence,” Computer Speech and Language, vol. 21, pp. 153-173, January 2007, by utilizing the best estimated cepstral vector ĉ as the observation.

The above training method uses a set of model parameters λₕ of a mapping model to describe the uncertainty of H_{c} predicted by f_{q}(c).

However, in an alternative embodiment, a deterministic case is assumed where f_{q}(c) perfectly predicts H_{c}. In this embodiment, there is no uncertainty between H_{c} and f_{q}(c) and thus λₕ is no longer required.

In such a scenario, the mapping model parameters are set to zero in step S209 of FIG. 5 and are not re-estimated in the S221 of FIG. 6.

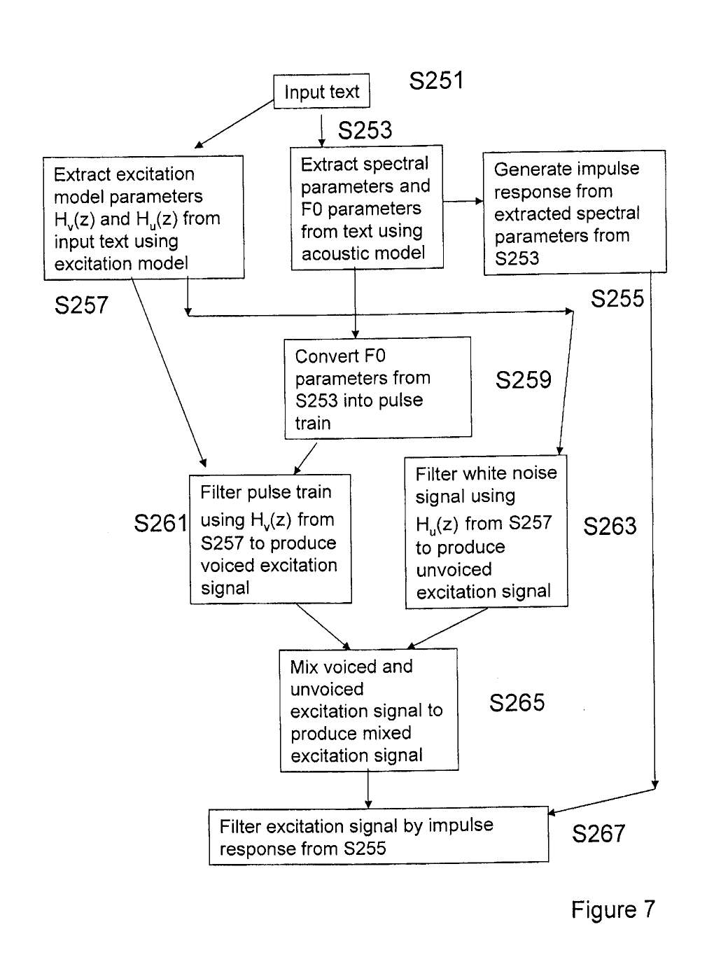

FIG. 7 is a flow chart of a speech synthesis method in accordance with an embodiment of the present invention.

Text is input at step S251. An acoustic model is run on this text and features including spectral features and F0 features are extracted in step S253.

An impulse response filter function is generated in step S255 from the spectral features extracted in step S253.

The input text is also inputted into excitation model and excitation model parameters are generated from the input text in step S257.

Returning to the features extracted in step S253, the F0 features extracted at this stage are converted into a pulse train in step S259. The pulse train is filtered using voiced filter function which has been generated in step S257.

White noise is generated by a white noise generator. The white noise is then filtered in step S263 using unvoiced filter function which was generated in step S257. The voiced excitation signal which has been produced in step S261 and the unvoiced excitation signal which has been produced in step S263 are then mixed to produce mixed excitation signal in step S265.

The mixed excitation signal is then filtered in step S267 using impulse response which was generated in step S255 and the speech signal is outputted.

By training acoustic and excitation models through joint optimization, the information which is lost during speech parameter extraction, such as phase information, may be recovered at run-time, resulting in synthesized speech which sounds closer to natural speech. Thus statistical parametric text-to-speech systems can be produced with the capability of producing synthesized speech which may sound very similar to natural speech.

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of methods and systems described herein may be made without departing from the spirit of the inventions. The accompanying claims and their equivalents are intended to cover such forms of modifications as would fall within the scope and spirit of the inventions.

1. A speech processing method comprising:
receiving a text input and outputting speech corresponding to said text input using a stochastic model, said stochastic model comprising an acoustic model and an excitation model, said acoustic model having a plurality of model parameters describing probability distributions which relate a word or part thereof to a feature, said excitation model comprising excitation model parameters which are used to model the vocal chords and lungs to output the speech using said features;
wherein said acoustic parameters and excitation parameters have been jointly estimated; and
outputting said speech.

2. A speech synthesis method according to claim 1, wherein said text input is processed by said acoustic model to output F0 and spectral features, the method further comprising: processing said F0 features to form a pulse train and filtering said pulse train using excitation parameters derived from said excitation model to produce an excitation signal and filtering said excitation signal using filter parameters derived from said spectral features.

3. A method of training a statistical model for speech synthesis, the method comprising:
receiving training data, said training data comprising speech and text corresponding to said speech;
training a stochastic model, said stochastic model comprising an acoustic model and an excitation model, said acoustic model having a plurality of model parameters describing probability distributions which relate a word or part thereof to a feature vector, said excitation model comprising excitation model parameters which model the vocal chords and lungs to output the speech;
wherein said acoustic parameters and excitation parameters are jointly estimated during said training process.

4. A method according to claim 3, wherein said acoustic model parameters comprise means and variances of said probability distributions.

5. A method according to claim 3, wherein the features output by said acoustic model comprise F0 features and spectral features.

6. A method according to claim 5, wherein said excitation model parameters comprise filter coefficients which are configured to filter a pulse signal derived from F0 features.

7. A method according to claim 3, wherein said joint estimation process comprises a recursive process where in one step excitation parameters are updated using the latest estimate of acoustic parameters and in another step acoustic model parameters are updated using the latest estimate of excitation parameters.

8. A method according to claim 3, wherein said joint estimation process uses a maximum likelihood technique.

9. A method according to claim 5, wherein said stochastic model further comprises a mapping model and said mapping model comprises mapping model parameters, said mapping model being configured to map spectral features to filter coefficients which represent the human vocal tract.

10. A method according to claim 3, wherein the parameters are jointly estimated as:
$$\hat{λ} = arg {max}_{λ} p ( s \vert l , λ ) ,$$
where λ represents the parameters of the excitation model and acoustic model to be optimised, s is the natural speech waveform and l is a transcription of the speech waveform.

11. A method according to claim 10, wherein λ further comprises parameters of a mapping model configured to map spectral parameters to a filter function to represent the human vocal tract.

12. A method according to claim 11, wherein the relationship between the spectral features and filter coefficients is modelled as a Gaussian process.

13. A method according to claim 11, wherein p(s|l,λ) is expressed as:
$$p ( s \vert l , λ ) = {\sum }_{∀ q} \int \int p ( s \vert {H}_{c} , q , {λ}_{e} ) p ( {H}_{c} \vert c , q , {λ}_{h} ) p ( c \vert q , {λ}_{c} ) p ( q \vert l , {λ}_{c} ) d {H}_{c} d c . \qquad ( 62 )$$
where H_{c} is the filter function used to model the human vocal tract, q is the state, λₑ are the excitation parameters, λ_{c} the acoustic model parameters, λₕ the mapping model parameters and c are the spectral features.

14. A method according to claim 13, wherein the summation over q is approximated by a fixed state sequence to give:
p(s|l,λ)≈∫∫p(s|H_{c},\hat{q},λₑ)p(H_{c}|c,\hat{q},λₕ)p(c|\hat{q},λ_{c})p(\hat{q}|l,λ_{c})dc, (63)
where \hat{q}={\hat{q}₀, . . . , \hat{q}_{T-1}} is the state sequence

15. A method according to claim 14, wherein the integration over all possible H_{c} and c is approximated by spectral response and impulse response vectors to give:
p(s|l,λ)≈p(s|Ĥc,\hat{q},λₑ)p(Ĥ_{c}|ĉ,\hat{q},λₕ)p(ĉ|\hat{q},λ_{c})p(\hat{q}|l,λ_{c}), (64)
where ĉ=[ĉ₁ . . . ĉ_{T-1}]^{T} is the fixed spectral response vector.

16. A method according to claim 15, wherein the log likelihood function of p(s|l,λ) is given by:
L=log p(s|Ĥc,\hat{q},λₑ)+log p(Ĥ_{c}|ĉ,\hat{q},λh)+log p(ĉ|\hat{q},λ_{c})+log p(\hat{q}|ₗ,λ_{c}). (65)

17. A carrier medium carrying computer readable instructions for controlling the computer to carry out the method of claim 1.

18. A speech processing apparatus comprising:
a receiver for receiving a text input which comprises a sequence of words; and
a processor, said processor being configured to determine the likelihood of output speech corresponding to said input text using a stochastic model, said stochastic model comprising an acoustic model and an excitation model, said acoustic model having a plurality of model parameters describing probability distributions which relate a word or part thereof to a feature, said excitation model comprising excitation model parameters which are used to model the vocal chords and lungs to output the speech using said features; wherein said acoustic parameters and excitation parameters have been jointly estimated, wherein said apparatus further comprises an output for said speech.

19. A speech to speech translation system comprising an input speech recognition unit, a translation unit and a speech synthesis apparatus according to claim 18.
